(19) United States
(12) Patent Application Publication
(10) Pub. No.: US 2006/0109083 A1
(43) Pub. Date: May 25, 2006

(54) Method and apparatus for accessing electronic data about at least one person of interest

(76) Inventors: Spencer A. Rathus, Sag Harbor, NY (US); John W. Olivo JR., Summit, NJ (US)

Correspondence Address: Ward & Olivo, 382 Springfield Avenue, Summit, NJ, 07901, US

(21) Appl. No.: 10/996,817

(22) Filed: Nov. 24, 2004

(51) Int. Cl. H04Q 5/22

(52) U.S. Cl. 340/10.1; 235/375

(57) ABSTRACT

The disclosed methods and apparatus relate generally to accessing electronic data about persons of interest. These methods and apparatus involve the interfaces among electronic devices, communication devices, and the storage, identification, and retrieval of personal information. Allow a user to select a person or survey a group of persons to access and make use of electronic media input and output devices by reference to and/or utilization of machine recognizable information associated with these persons.

### FIELD OF THE INVENTION

The invention is related to the field of access and retrieval of electronic data. In particular, the invention is related to the use of electronic media to store, input, and output machine recognizable information. The invention permits people to gather/obtain information about one another and to communicate with one another.

### BACKGROUND OF THE INVENTION

The benefits of accessing information about a person before extensively interacting with that person are well known. For example, health professionals routinely review the medical history of patients before treating them. Security personnel usually examine the identification documentation of people seeking access to buildings, airports, national borders, etc. before determining whether to allow them access. Individuals looking for companionship often read the profiles and/or view pictures of possible mates before deciding whether to actually meet them. In short, it is advantageous to learn as much information about a person as one can before interacting with that person, because it increases the chances of a fruitful interaction.

The two most time-honored ways of learning about people before extensively interacting with them are to observe “body language” and other behavioral patterns, or to view documents containing printed information about them. These “documents” have come to include not only traditional sheets of paper, but identification bracelets, identification cards, and the like, which can also be made out of plastic or any other suitable material known in the art.

As electronic technology progressed and with the advent of the computer, electronic devices were introduced which allowed users to gain access to information about people of interest without the need to view paper documents. Electronic recognition of indicia (such as magnetic strips on credit cards), combined with a computer's capability to store information, made it easier for people with information to carry it and make it accessible to others. It also became easier for people who desired information to retrieve and view it quickly with the help of an electronic device such as a credit card reader.

The advent of the Internet combined with the proliferation and affordability of wireless communication devices has greatly expanded the methods by which information can be traded among individuals. It has also allowed for an expansion of the types and quantity of information that a person can review before interacting with someone else. For example, many people are now relying on hand-held wireless communication devices, the Internet, computerized “instant messenger,” web cams, and the like to enhance (if not create) their social lives. Communication between people over the Internet has become a popular pastime. Internet message boards, personal online profiles, and chat rooms allow people seeking to interact with like-minded individuals to learn about those people before physically meeting them. This can be beneficial to both parties; it removes the awkwardness that can be associated with a first conversation and establishes that there are at least some base-level interests that both people share.

Traditional paper-based identifiers have been modified for use with the Internet. For example, non-electronic identification tags, bracelets, etc. have come to include web addresses, so that someone interested in getting more information about the wearer can view the identification tag, read the web address, and go to that address when they are next at a computer to obtain more information about the wearer. Rudimentary electronic identifiers followed. At first, they contained audio and/or video identification information. These devices, however, still required a person interested in obtaining the information on the identifier to physically view it and/or depress some type of control mechanism to obtain the information. Improvements were made whereby a hand-held electronic reader could extract the information on the identifier. These electronic readers generally consisted of memory devices, data transmitters, and various security indicators. Importantly, each of these two types of electronic identification systems were limited in that only the information stored “locally” inside the identifier could be retrieved. Also, as with previous forms of identification, these systems required very close physical proximity between the wearer and the reader. Therefore, remote identification with these devices was almost impossible. Additionally, these systems generally required system-specific readers.

There are many Internet services that ask users to enter data (personal photo, interests, occupation, specifically looking for, etc.), which is then formatted into a profile for others to view. A countless number of these profiles can be viewed by a potential “match” before he or she decides to make contact with any specific individual. Other online services remove the legwork from the equation altogether, by matching users based on similarities in their online profiles. An individual can then review the profiles of the proposed matches “incognito” before deciding whether to contact one or more of them.

Unfortunately, most of these systems are not lie-proof, and are susceptible to users giving false or misleading information. Also, the previously mentioned systems are often accessed via personal computers in homes, offices, and the like. Thus, it is often the case that the person viewing a profile and the person who the profile belongs to are not in close proximity to one another—they may be streets, towns, cities or states away from each other. Therefore, these systems' ability to allow individuals to input false and misleading statements is especially problematic, because the distance between the profile viewer and the profile holder does not allow for immediate verification of the information in the profile.

Other systems enable communication between wireless devices such as cell phones, PDAs, and the like. The devices utilized by these systems broadcast signals that contain identifying information so that devices capable of receiving the information can collect it, transfer it to a remote database, and extract profiles associated with said users from said remote database. These systems, broadcast one's availability and profile indiscriminately within a given geographical area. Moreover, they provide no method whereby a user of the system, in passing or seeing a person who elicits interest, can “scan” that individual to ascertain whether or not that individual has descriptive electronic data available, along with means of establishing contact. Nor do they allow a user to scan a group of people to determine which ones have electronic data available and what that data is.

Therefore, available methods and systems for obtaining information about other people are limited in several important respects. Specifically, no presently known system allows a user of an electronic device to: view another person (a “person of interest”), and if desired, to emit a signal to inquire about the identity and/or profile of said person of interest, to obtain information about said person of interest stored in an object associated with said person, and if appropriate to use said information to access additional remotely stored information about said person, and, if desired, to establish communication with said person. In addition, no presently known system allows a user of an electronic device to emit a signal to inquire about the identities and/or profiles of at least one other person in a geographic area such as a lounge, club, or the like, and if desired to obtain more information about said at least one person stored in an object associated with said person, and if appropriate to use said information to access additional remotely stored information about said at least one person, to obtain information about the locations of said at least one person, and if desired, to establish communication with said person. There is a clear need for a system with such characteristics. The present invention is such a system.

### SUMMARY OF THE INVENTION

In view of the foregoing, it is an object of the present invention to provide apparatus and methods for allowing a user to access electronic data about a person or persons of interest by accessing coded information in an object associated with said persons.

It is a further object of the present invention to provide apparatus and methods for allowing a user to establish contact with a person or persons of interest.

It is a further object of the present invention to utilize the disclosed apparatus and methods in compliance with an Internet dating service.

Another object of the present invention is to utilize the disclosed apparatus and methods in compliance with an Internet based job search service.

Another object of the present invention is to utilize the apparatus and methods to acquire commercial and retail services such as transportation, real estate, consumer products, and the like.

Another object of the present invention is to utilize the apparatus and methods in conjunction with authorities to disclose information such as criminal records, association with terrorist organizations, travel history, citizenship, immigration/visa status of a person(s), or the like.

Another object of the present invention is to utilize the disclosed apparatus and methods in the medical field to disclose information such as medical records and other medical related information.

Another object of the present invention is the creation of objects containing machine recognizable features that can be “read” by electronic devices. Another object of the present invention is the adaptation of existing electronic and communication devices to serve as feature recognition units that can “read” the machine recognizable features of objects associated with a person or persons of interest.

Another object of the present invention is the creation of a more sophisticated identification system comprising an object having a machine recognizable feature and an apparatus that can read said feature for the purpose of identifying and retrieving electronic data of medical patients, criminals, lost children, potential romantic partners, and other persons of interest.

In accordance with one embodiment, the invention comprises: (i) At least one object having at least one machine-recognizable feature and (ii) a feature recognition unit having means for recognizing said features, means for associating said recognized features with a command, and means for issuing said command over a wireless link. In use, the user scans an area containing a group of people and said feature recognition unit acquires signals from said machine recognizable features on said objects. In response, said feature recognition unit associates said features with a pre-programmed command and issues a pre-programmed command sequence over a wireless data link to identify individuals who possess said objects, display their locations, and access electronic data or electronic media services, if desired.

In accordance with another embodiment, the invention comprises: (i) At least one object having at least one machine-recognizable feature and (ii) a feature recognition unit having means for recognizing said features, means for associating said recognized features with a command, and means for issuing said command over a wireless link. In use, the user scans an area containing a group of people and said feature recognition unit acquires signals from said machine recognizable features on said objects. In response, said feature recognition unit associates said features with a pre-programmed command and issues a pre-programmed command sequence over a wireless data link to identify individuals who possess said objects, and display their visual representation, access electronic data or electronic media services, if desired.

In accordance with another embodiment, the invention comprises: (i) An object having associated therewith at least one machine recognizable feature such as a bar code, a magnetic strip, a radio frequency identification device, an infrared tag, a quantum dot or any other indicia, (ii) a feature recognition unit having a means for recognizing said feature and a transmitter, and (iii) a controller having a receiver. The user directs the feature recognition unit to a feature on said object. In response, said feature recognition unit transmits a signal indicative of the identity of the particular feature. The receiver receives said signal, and said controller, in response thereto, executes an appropriate pre-programmed command.

In accordance with another embodiment, the invention comprises: (i) An object having at least one machine recognizable feature and (ii) a feature recognition unit having means for recognizing said feature, means for associating said recognized feature with a command, and means for issuing said command over a wireless link. In use, the user directs said feature recognition unit at a feature on said object. In response, said recognition unit associates said feature with a pre-programmed command and issues a pre-programmed command sequence over a wireless data link to control or access electronic data or electronic media services. The command may, for example, be transmitted to a global positioning satellite or to a remote server.

Another aspect of the invention provides a means whereby a user of the system can initiate or respond to contact with persons associated with objects, the steps comprising: (i) at least one object having at least one machine-recognizable feature and (ii) a feature recognition unit having means for recognizing said features, means for associating said recognized features with a command, and means for issuing said command over a data link. In use, the user scans a person of interest or an area containing a group of people and said feature recognition unit acquires signals from said features on said objects. In response, said recognition unit associates said features with a pre-programmed command and issues a pre-programmed command sequence to identify individuals who possess said objects and display their locations. The user may download electronic data from the machine-recognizable feature that may contain a profile such as a personal interest, professional, medical, criminal, commercial, or the like profiles about person of interest. Upon receipt of said data file or at a later time, the user may send a corresponding electronic data file to the person of interest. Said user of the system and/or said person of interest can further exchange messages as to whether they should meet in person and can make arrangements for same.

Another aspect of the invention provides a means whereby a user of the system can initiate or respond to contact with—persons associated with objects, the steps comprising: (i) At least one object having at least one machine-recognizable feature and (ii) an feature recognition unit having means for recognizing said features, means for associating said recognized features with a command, and means for issuing said command over a data link. In use, the user scans a person of interest or an area containing a group of people and said feature recognition unit acquires signals from said features on said objects. In response, said recognition unit associates said features with a pre-programmed command and issues a pre-programmed command sequence to identify individuals who possess said objects and display their visual representations. The user may download electronic data from the machine-recognizable feature that may contain a profile such as personal interest, professional, medical, criminal, commercial, or the like profiles about person of interest. Upon receipt of said data file or at a later time, the user may send a corresponding electronic data file to the person of interest. Said user of the system and/or said person of interest can further exchange messages as to whether they should meet in person and can make arrangements for same.

Another aspect of the present invention comprises an electronic bracelet or other object having a machine recognizable feature. However, this disclosure is not to limit the scope of the invention and is only one embodiment of said object. Additional embodiments can be seen in the claims section of this document. In a social environment, the wearer of the bracelet or other object having a machine-recognizable feature can provide electronic data to individuals with feature recognition units. The object having a machine-recognizable feature may house a compartment which contains a memory unit, wireless capability, and a power supply. Each object having a machine recognizable feature also has an associated address to distinguish it from other like devices. Lightweight composite materials that would minimize frequency interference may be used to make up the object having machine recognizable features. Other objects having machine recognizable features may be composed of plastic if they are to be placed in a badge, or composed of metal if they are to comprise a portion of a necklace, bracelet, earring, or other piece of jewelry.

In still another embodiment, the invention provides a means whereby a user of the system can initiate or respond to contact with persons associated with communication devices, the steps comprising: (i) At least one communication device having at least one machine-recognizable feature, (ii) at least one communication device having means for recognizing said features, means for associating said recognized features with a command, and means for issuing said command over a data link, wherein (iii) both said user and said person of interest use communication devices. In use, the user scans a person of interest or an area containing a group of people with his or her communication device, and said feature recognition unit associated with said device acquires signals from said features on said devices associated with persons of interest. In response, said recognition unit or controller associates said features with a pre-programmed command and issues a pre-programmed command sequence to identify individuals who possess said devices and display their visual representation. The user may download electronic data from said persons of interest's machine-recognizable feature that may contain a profile such as a personal interest, professional, medical, criminal, commercial, or the like profiles about person of interest. Upon receipt of said data file or at a later time, the user may send a corresponding electronic data file to said person of interest. Said user of the system and/or said person of interest can further use their communication devices to exchange messages as to whether they should meet in person and can make arrangements for same.

### BRIEF DESCRIPTION OF THE DRAWINGS

These and other features and advantages of the invention will become more apparent upon reading the following detailed description and upon reference to the accompanying drawings.

FIG. 1A shows a system of the present invention in practice, whereby a user of the system utilizes a device such as a web-enabled cellular telephone with a feature recognition unit to access electronic data about a person of interest from an object such as an electronic bracelet attached to said person via a wireless network.

FIG. 1B shows a block diagram displaying the steps of the method illustrated in FIG. 1A.

FIG. 2A shows a system of the present invention in practice, whereby a user of the system utilizes a cellular telephone with a feature recognition unit to specifically scan the object such as an electronic bracelet attached to a person of interest and to access electronic data about a person of interest via a wireless network.

FIG. 2B shows a block diagram displaying the steps of the method illustrated in FIG. 2A

FIG. 3 shows a block diagram displaying the steps of an alternate system of the present invention in practice, whereby the user of the system utilizes a web-enabled cellular telephone with a feature recognition unit to access electronic data about a person of interest from the electronic bracelet via a wireless network; further the user of the system uses said electronic data to retrieve additional information about said person of interest through a remote server according to the principles of the present invention.

FIG. 4 shows a system of the present invention in practice, whereby a user of the system utilizes a web-enabled computer to access electronic data about a person of interest from a remote server via a wireless network.

FIG. 5A shows a system of the present invention in practice, whereby a user of the system utilizes GPS and web-enabled cellular telephone with a feature recognition unit to access electronic data about a person of interest from the electronic bracelet attached to said person via positioning system.

FIG. 5B shows a block diagram displaying the steps of the method illustrated in FIG. 5A.

FIG. 6 shows a block diagram displaying the steps of an alternative system of the present invention where user of the systems uses a GPS and web-enabled cellular telephone with a feature recognition unit to access electronic data about a person of interest from the electronic bracelet attached to said person via a positioning system.

FIG. 7A shows a person's wrist with an electronic bracelet having a machine recognizable feature attached thereto.

FIG. 7B shows a close up of an electronic bracelet having a machine recognizable feature and its structural components.

FIG. 8 shows a block diagram of the present invention displaying the interaction of the various electronic components of a system of the present invention.

FIG. 9 shows an alternative system of the present invention in practice, whereby a user of the system utilizes a device such as a cellular telephone with a feature recognition unit to access electronic data about a person of interest from an object having at least one machine recognizable feature implanted in the arm of said person of interest.

FIG. 10A shows a system of the present invention in practice, whereby user of the system utilizes a GPS and web-enabled cellular telephone with a feature recognition unit to access electronic data about a person of interest via GPS system.

FIG. 10B shows a block diagram displaying the steps of the method illustrated in FIG. 10A.

FIG. 11 shows an alternative system of the present invention in practice, whereby a user of the system utilizes a communication device with a feature recognition unit to access electronic data about a person of interest from a communication device associated to said person via local GPS system.

FIG. 12 shows a visual display means for selectively choosing a person of interest on a communication device according to the present invention via a GPS system.

FIG. 13A shows an alternative embodiment of a visual display means for selectively choosing a person of interest on a communication according to the present invention via visual representation in a list form.

FIG. 13B shows another alternative embodiment of the visual display means for selectively choosing a person of interest on a communication device according to the present invention via visual representation in a list form which allows the user to choose categories.

### DETAILED DESCRIPTION OF THE DRAWINGS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Certain terminology will be used in the following description for convenience in reference only and will not be limiting. The reference to a user of the system and a person of interest will refer to the people using the system, it is not to say that a person of interest is not a user or a user is not a person of interest. Such terminology will include the words above specifically mentioned, derivatives thereof and words of similar import.

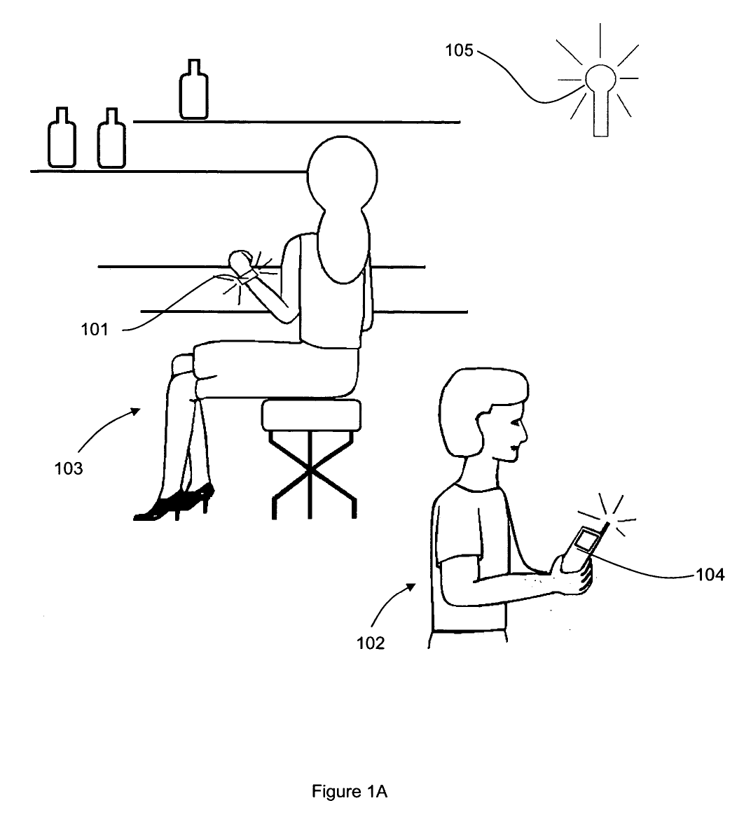

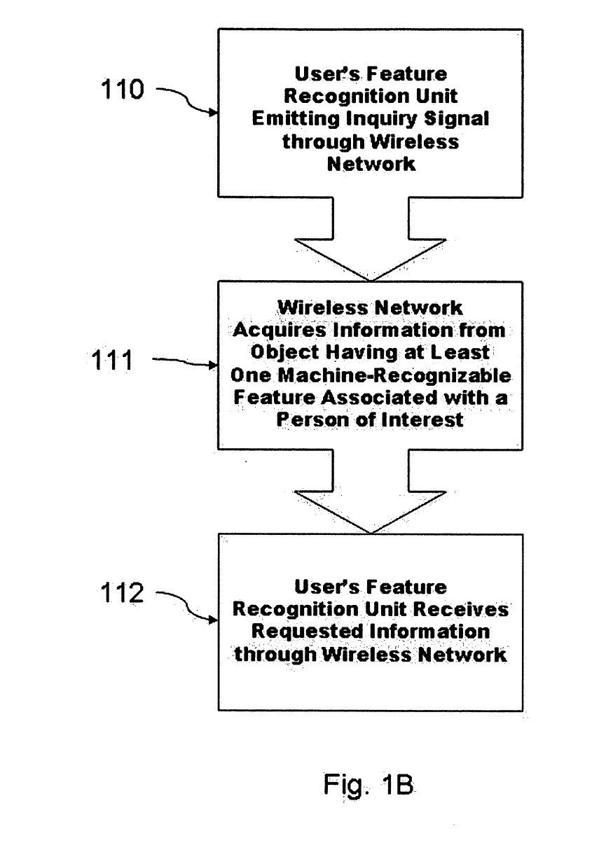

FIGS. 1A and 1B provide an example scenario of the method for using the invention comprising an object, in this case a bracelet 101, having at least one machine-recognizable feature, and a feature recognition unit, in this case a cellular telephone 104, having means for recognizing said features. The user 102 is in the same general area as the person having the object. He is using his feature recognition unit 104 to extract information from the object having at least one machine-recognizable feature 101 belonging to the person of interest 103 through any available wireless network 105. In this case, the user need not see the object 101 in order to extract information from it.

The feature recognition unit could be in any form including, but not limited to a hand-held device, a cellular telephone, hybrid cellular telephone/PDA device, remote server, PDA, RFID, personal computer, laptop computer, pocket computer, hybrid electronic device, or the like. The object having at least one machine-recognizable feature 101, belonging to the person of interest 103, can take any form as well. This form may include, but is not limited to a piece of jewelry (bracelet, earring, necklace, etc.), an article of clothing, a card (credit, bank, identification, etc.), a badge, a tag (name, RFID, IR, etc.), an ornament, or the like. In addition, the network could be in any form including, but not limited to a wireless, GSM, ISDN, Ethernet, CATV, WiFi, any type of LAN, Bluetooth, or the like. The feature recognition unit would connect to the wireless network 105 using a receiver to receive and a transmitter to transmit coded signals to the object having at least one machine-recognizable feature 101.

The object having at least one machine-recognizable feature 101 has a memory chip component along with a transmitting component. The memory chip could contain a profile of the person of interest 103 or could include a address of a web page on the world wide web (a universal resource locator, or URL) to a profile. The profiles could be in any form but not limited to a personal interest, medical, criminal, commercial, professional, or the like. For example, if the object having at least one machine-recognizable feature 101 is used for the purpose of meeting people the profile could be as limiting as the user would like, containing, for example, a name or pseudonym, a screen name, text information, visual features, personal traits, demographic characteristics (age, ethnicity, income, leisure, activities, etc.), photographs, audio, video clips, or the like.

However, for the instance the object having at least one machine-recognizable feature 101 is used for more restrictive purposes as for medical patient identification the profile would be controlled by the medical personnel and would contain, but not limited to medical records or other medical information. For example, individuals having a chronic illness may regularly wear an identification bracelet or other object having a machine recognizable feature 101. In the instance that they have a recurrence, any authorized medical personnel or other authoritative individual may acquire a password protected medical information about the affected person through available wireless Internet based device. This would provide a more secure environment for the sickly, elderly, or the like.

In use of the invention, the user 102 commands his feature recognition unit 104 to acquire information about persons in the area, including said person of interest 103. Said machine-recognizable feature can be active, as in the case of radio frequency identification (RFID) device that either continually emits a signal or emits a signal upon reception of an inquiry signal from said user's feature recognition unit through a wireless network 105, 110. Or said machine-recognizable feature can be passive, as in the case of a magnetic strip or a bar code. In the case in which the machine-recognizable feature responds to interrogation from said user's feature-recognition unit, said object having at least one machine-recognizable feature 101 will receive the inquiry signal and transfer its information back to the feature recognition unit 104 through the wireless network 105, 111. The signal could be of any type but not limited to electromagnetic, radio, IR, or the like. User's feature recognition unit 104 would then receive and download the requested information, 112. The user 102 is then able to view the profile of the person of interest 103 on a display unit. This unit could be any type of screen or projection component. As well, the display unit could be incorporated into the feature recognition unit or an attachment thereof.

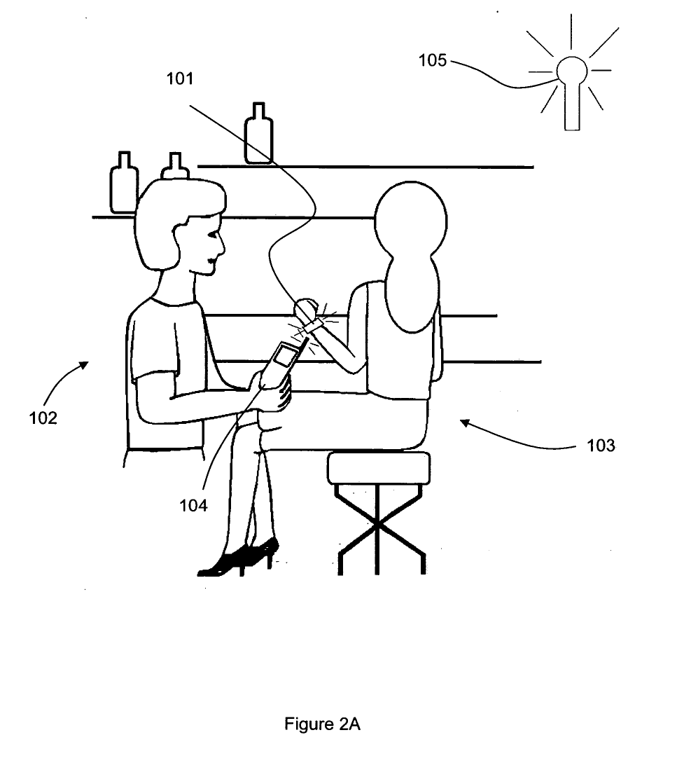

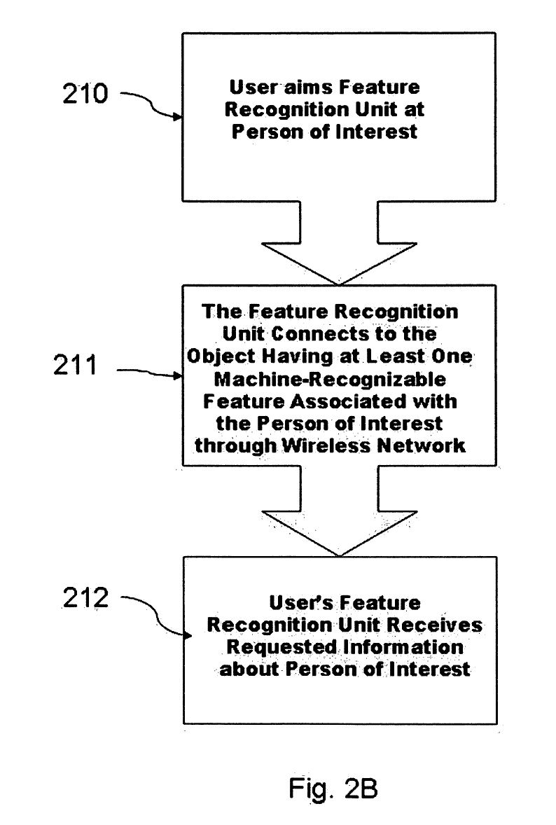

FIGS. 2A and 2B represent another embodiment of the invention: an object having at least one machine-recognizable feature such as a radio frequency identification (RFID) device, a bar code, a magnetic strip, an infrared tag, a quantum dot, or any other indicia-in this case, a bracelet 101, and also a feature recognition unit having a means for recognizing said feature and a transmitter, in this case a cellular phone 104. The user 102 can acquire information from the machine-recognizable feature associated with the object 101. However, in this embodiment the user 102 first visually identifies said object 101 and then, if desires, can choose to use an interrogating or scanning component that is available on the feature recognition unit 104. Interrogating or scanning enables the user 102 to select the individual 103 about whom he wishes to access electronic data. For example, if such system is used for job searching applications, the user 102 can acquire hiring information from an interviewer 103 by scanning his/her object 101.

In use, the user 102 will aim his feature recognition unit 104 at the person of interest 103 and command the feature recognition unit 104 to acquire information about person of interest 103, 210. The feature recognition unit 104 will then scan the object having at least one machine-recognizable feature 101 which enables it to connect to the object having at least one machine-recognizable feature 101 through a wireless network 105, 211. The information will then transfer onto the feature recognition unit 104 and will be available for the user 102 to view, 212.

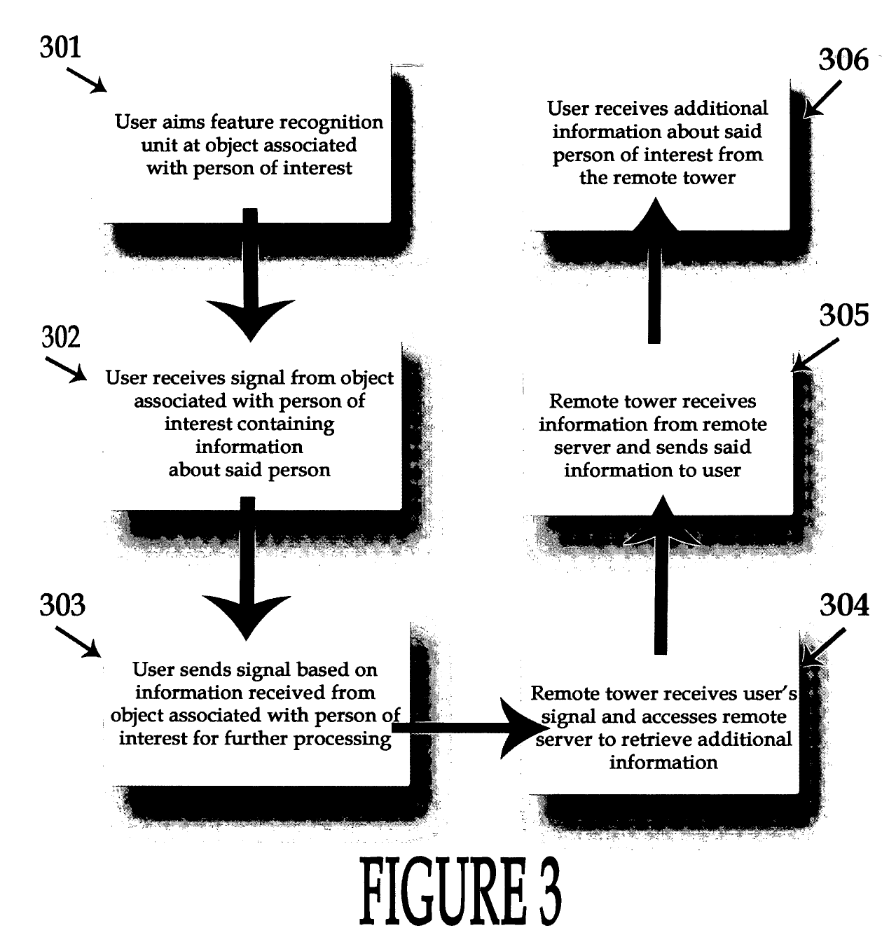

Since the object having at least one machine-recognizable feature 101 may be limited in the storage capacity of its memory, the system can allow the user to access further information stored in a remote server. FIG. 3 shows the method of retrieving said further information.

The object having at least one machine-recognizable feature 101 can store an address or a link associated with further information about the person of interest 103 and transfer it to the user's unit 104, 303. Said unit 104 will then send a signal to a remote tower to connect with a remote server through a wireless network 105, 304. The remote server will access further information with the address provided and transmit the information back to the user's feature recognition unit 104, 305. The unit 104 will receive the additional information and display it to the user 102 of the system, 306.

For instance, the invention could be utilized by authorities, such as police personnel 102. The police personnel can extract criminal information about a suspect 103 using the feature recognition unit 104, which can identify the suspect 103 through his/her corresponding object 101. Then the feature recognition unit 104 can use the identification information and connect to a criminal data base through a remote server and display it to the police personnel to review the suspect's 103 criminal records.

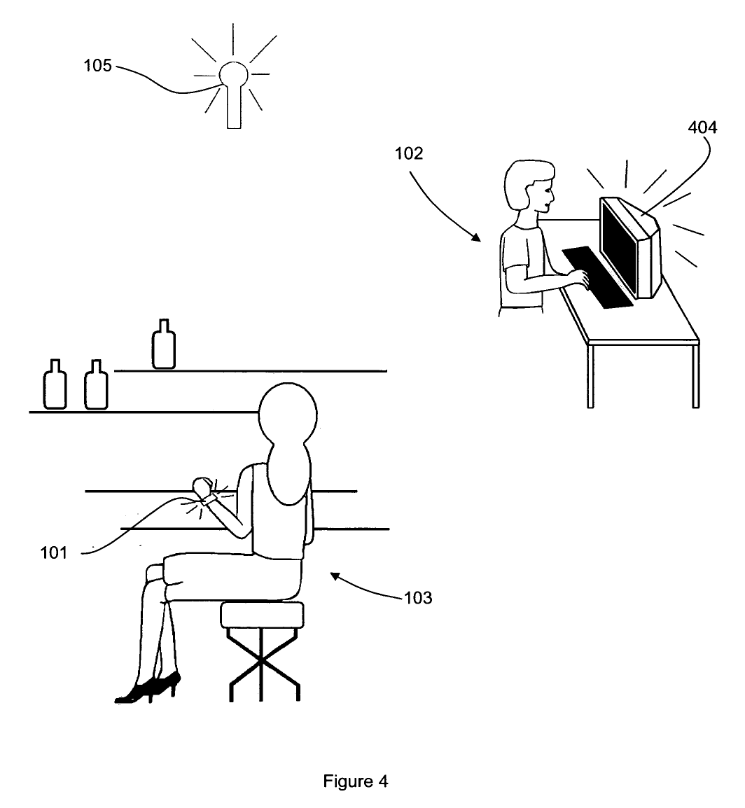

FIG. 4 exemplifies yet another method for acquiring information about the person of interest 103, wearing the object having at least one machine-recognizable feature 101. In this example, the user 102 first acquires information from objects associated with multiple persons of interest 103 in a social setting. Second, in a separate environment, the user 102 can later review the information acquired from various persons of interest 103 on a unit 404. The unit 404 used by user 102 could be in any form, for example, a desktop pc, a lap top, a web-enabled cellular telephone, or any other device having capabilities of processing date and/or communicating.

The acquired information could include an address corresponding to the object having at least one machine-recognizable feature 101 or a link to further information from a remote server about the person of interest 103. Using the information the user may choose to review further information stored on the remote server. Further, the user 102 can use the remote server with wireless capabilities 105 to access the person of interests' 103 object having at least one machine-recognizable feature 101. As long as both entities, the transmitting object having at least one machine-recognizable feature 101 and wireless reading unit 404, are connected to the Internet, whether through the same network or not, the object having at least one machine-recognizable feature 101 is accessible from any location.

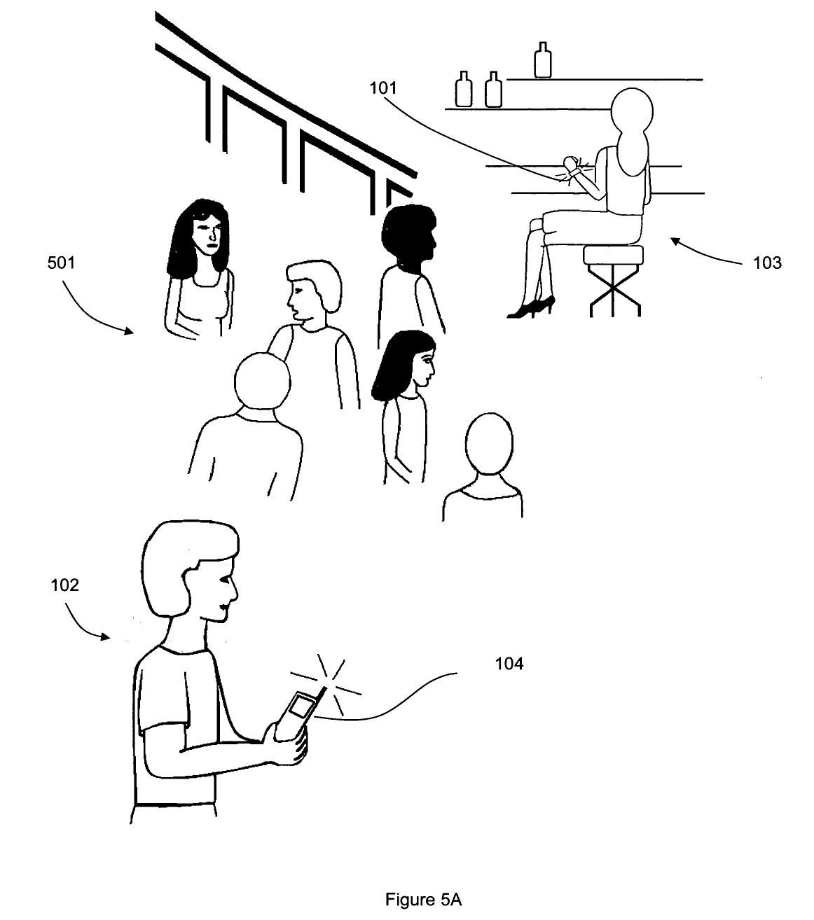

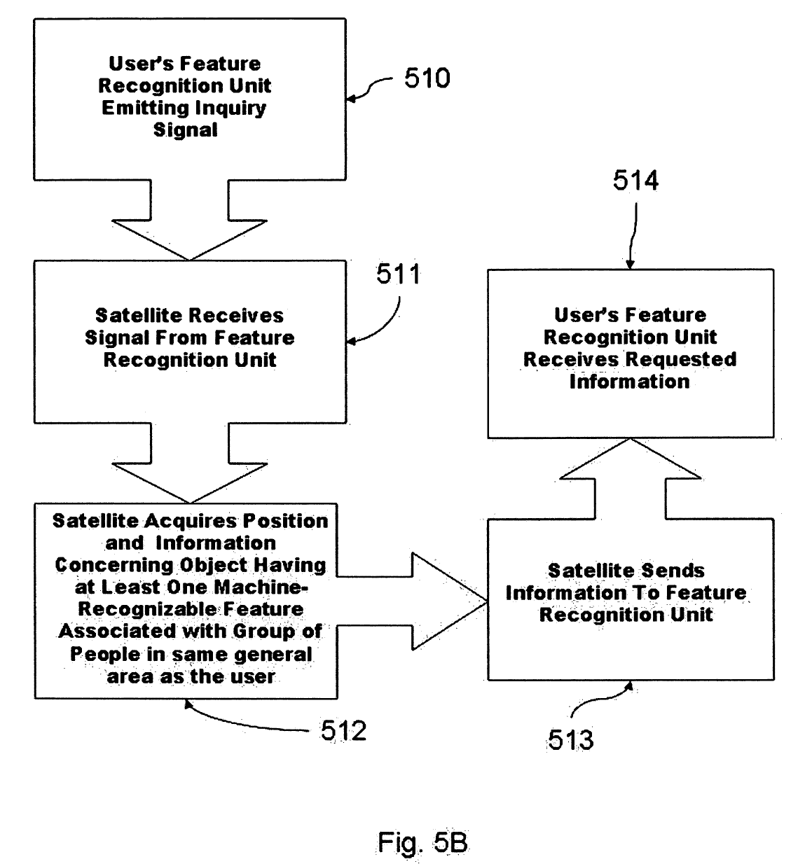

Another embodiment of this invention, shown in FIGS. 5A and 5B, implements a Global Positioning System (GPS) to allow the user of the system 102 to track and retrieve information from an object having at least one machine-recognizable feature 101 associated with a person of interest 103. The figure shows the user 102 using a GPS and web-enabled feature recognition unit 104 to scan an area containing group of people 501 and retrieve information. The object having at least one machine-recognizable feature 101 associated with the person of interest 103 contains a GPS locator which enables a satellite to track its location.

In Global Position System (GPS) enabled devices, location is determined by triangulating the signals generated by high-orbit satellites. A network of high-orbit satellites generates a pseudo-random code that can be used with relatively simple principles to very accurately determine (to within centimeters) positions on the Earth. By transmitting its calculated position over a communications system, a GPS enabled device can make its position known to other devices. If this other device is also GPS enabled, the two devices can calculate their relative positions and determine a route between them.

In use, the user's 102 feature recognition unit 104 emits inquiry signal 510 which is received by a satellite 511. The satellite will determine user's 102 location and calculates positioning information of persons of interest 501 and 101 associated with objects having at least one machine-recognizable feature 101 located in the same general area, 512. This information is then sent to the user's feature recognition unit 104, 513 and the user 102 can view the received information including position of persons of interests 501 and 101 as well as their profiles or other data, 514.

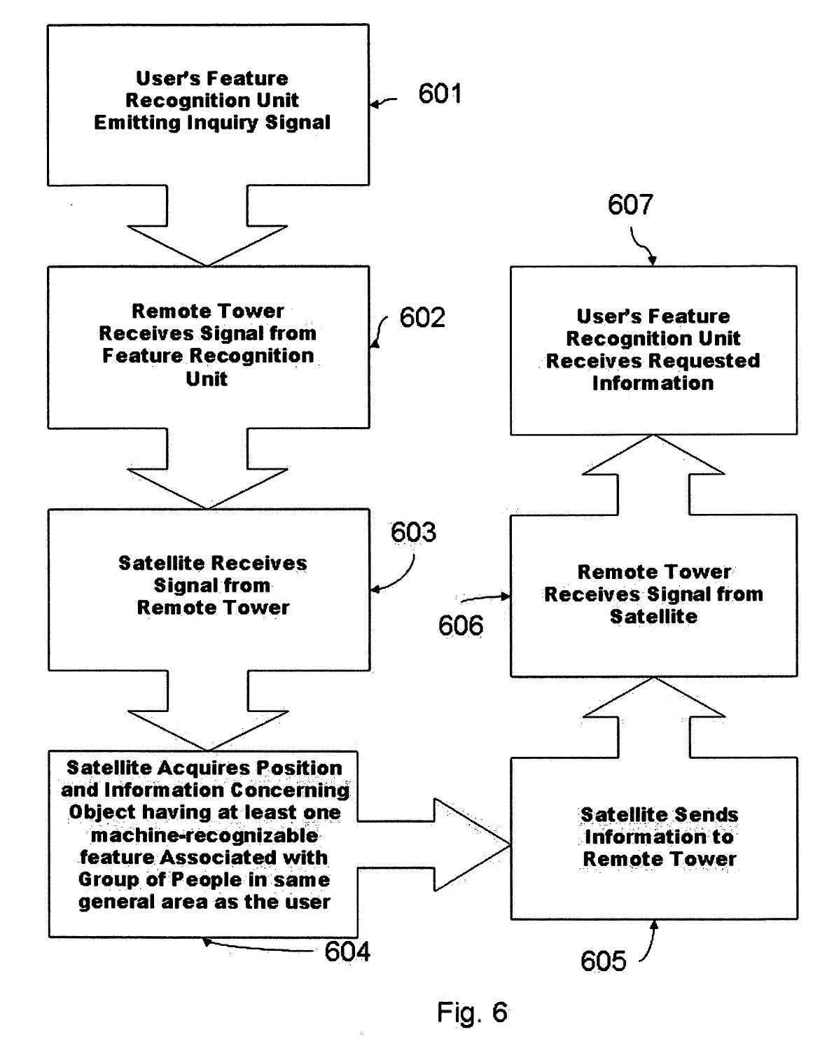

A similar system can also be implemented through a remote tower, as shown in FIG. 6. In this example, the signal emitted by the user's feature recognition unit 601 is received by a remote tower 602 which then transfers it to the satellite 603. The satellite performs all requested tasks, such as locating the user and the persons of interest located in the same general area as the user, 604. This information is sent back to the remote tower 605 which transfers it back to the user's feature recognition unit 601, which displays it, 606.

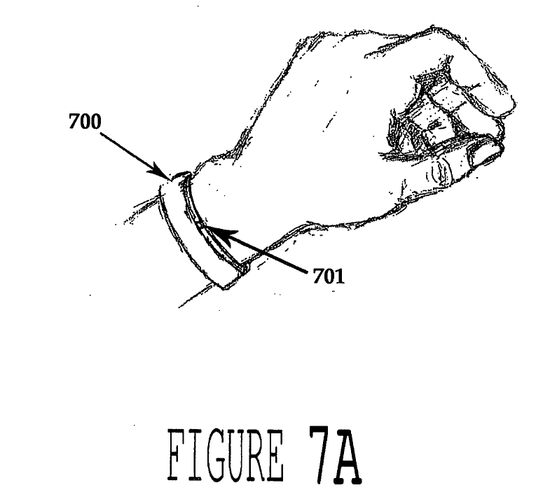

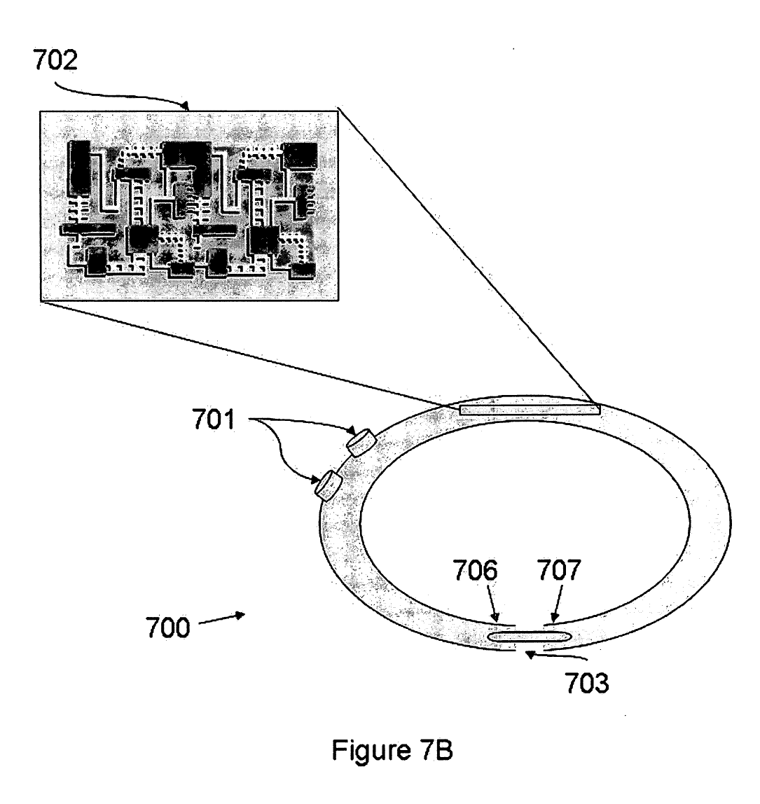

FIGS. 7A and 7B present one embodiment of the object having at least one machine-recognizable feature in the form of a bracelet. The user would wear said electronic bracelet 700 on his arm and can manually interact with it through controls 701. This embodiment is merely an example, the components used in the electronic bracelet 700 and the method of operation is the same when used in any other embodiment of the object having at least one machine-recognizable feature. The bracelet or any other object having at least one machine-recognizable feature 700 could contain a compartment to house various electrical components 702 such as memory, sensors, transmitters, etc.

Various control switches 701 could be integrated to the bracelet or any other object having at least one machine-recognizable feature to command various electronic components to perform certain tasks. One type of control switch could be a power switch which allows the user to activate or de-activate the electronic components when desired. The control switches 701 are not limited to be located as shown, but could be in any location desired on the bracelet or any other object having at least one machine-recognizable feature.

In another embodiment, the power switch could be integrated to the bracelet's clasp 703. The bracelet's band would have conductive contacts, 706 and 707, that form a short circuit when contact between them exist at the clasp 703. Small current is passed though the contacts, which commands the power of the bracelet to turn on. When the bracelet is opened (i.e. the user is not wearing the bracelet 700), the contacts 706 and 707 lose contact, creating an open circuit and which turns off the bracelet's power. In the case of other form of object having at least one machine-recognizable feature of wearable form, such power switch can be integrated similarly to any fastening means of the object having at least one machine-recognizable feature. For example, in the case a necklace is used as the object having at least one machine-recognizable feature, the power switch could be integrated into the necklace's fastening clasp.

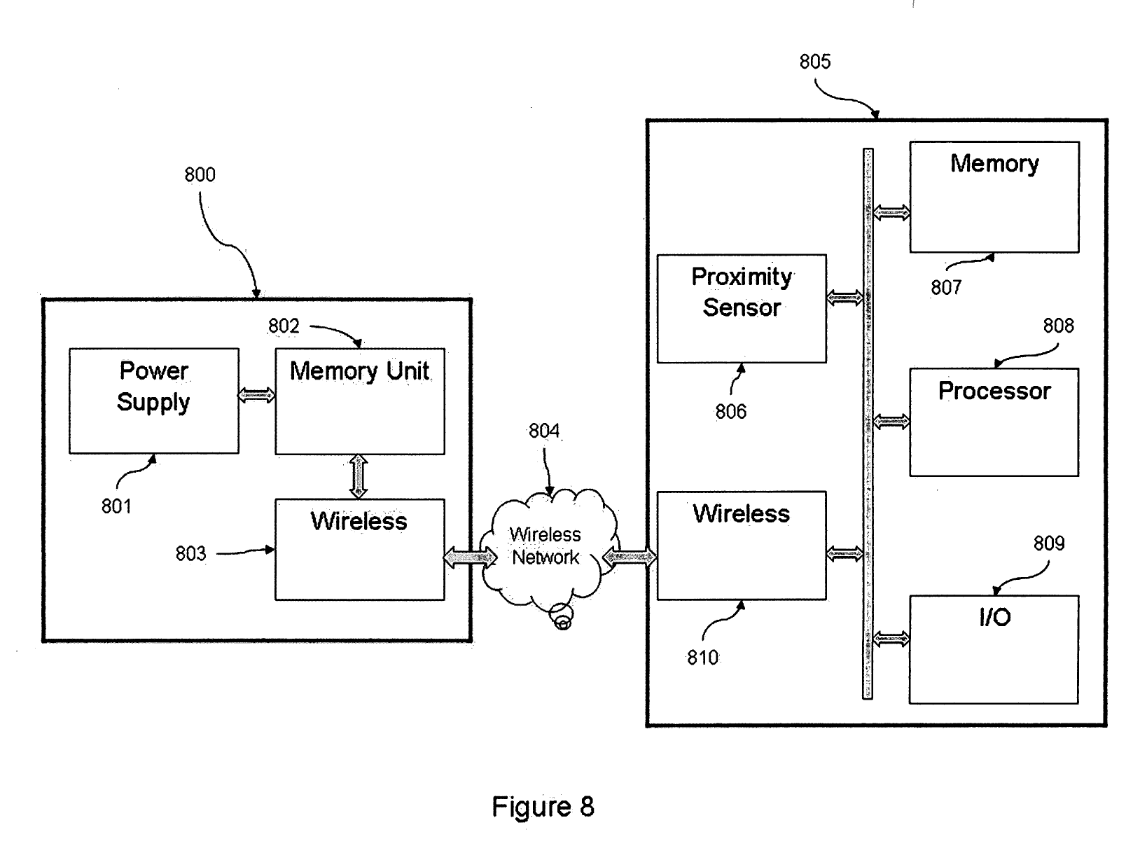

The internal components of an object having at least one machine-recognizable feature 800 and its implementation with a feature recognition unit 805 are represented in block diagram in FIG. 8. The memory unit 802 of the object having at least one machine-recognizable feature 800 can be similar to flash drives currently on the market. To provide the person of interest with a comfortable object having at least one machine-recognizable feature 800, the memory unit 802 provided is extremely small and light weight; however, it has extensive memory capabilities in order to store transmitted information. The memory unit 802 capability could be a random access memory (RAM) which has “read” and “write” capabilities, that is the information in the chip can be erased and rewritten as the user desires.

A simple stack program such as First In First Out (FIFO), could be used to stack the received data onto the memory 807 associated with the feature recognition unit 805. This type of stack program takes little processing and organizes the stored information in a “stack” that essentially places the stored information in “slots.” It writes to the top slot of the stack and retrieves from the bottom slot. Many other programs can also be used for sorting, stacking, etc. in order to organize the gathered information. However, FIFO would allow the user to determine the information in a sequential order. If said user stored information at one social event and later stored information from a different social event, the FIFO implementation would provide a sequential order of files, simplifying retrieval of data.

To facilitate communication, the object having at least one machine-recognizable feature 800 and the feature recognition unit 805 could have wireless capabilities 803 and 810. Through the wireless network 804, the user could command the feature recognizing unit 805 through a I/O 809 device to actively identify an object having at least one machine-recognizable feature 800 in the area and retrieve information to be stored on the memory 807. Said information could be downloaded to the memory 807 or the memory 807 could simply store the web links to such information. This method is similar to transmission between AOL instant messenger on computers and cellular devices.

In order to set boundaries to the amount of objects having at least one machine-recognizable feature 800 the feature recognizing unit 805 should communicate, a proximity sensor 806 could be to allow the user to set a desirable distance range to scan an area containing group of people. The proximity sensor 806 determines the strength of the signal from an object having at least one machine-recognizable feature 800 and, essentially, whether the ability transmit/receive information exists. The sensor 806 then calculates the distance and, if the object having at least one machine-recognizable feature 800 falls within the specified range, allows its signals to be received.

A power supply 801 could be integrated into the object having at least one machine-recognizable feature 800 to power its components. Said power supply 801 could comprise a small dispensable battery generally used in watches. In another embodiment, object having at least one machine-recognizable feature 800 could use a rechargeable battery, such as a lithium ion battery, and have a docking station like a jewelry box where it could be charged and/or kept. In still other embodiments, said object having at least one machine-recognizable feature 800 could be powered by a power cord, by the body heat of the person having the device, by solar power, by ambient light, by the electromagnetic field generated by that feature recognition unit, or by an ambient electromagnetic field.

Another possible embodiment of this invention is to implement the object having at least one machine-recognizable feature 800 to be able to read other objects having at least one machine-recognizable feature, i.e. to be a feature recognition unit at the same time. The object having at least one machine-recognizable feature 800 could use a command switch having associated therewith the feature recognition unit. This switch would activate the wireless capability 803 to receive information from the desired group of individuals associated with objects having at least one machine-recognizable feature, and store it into the memory chip 800.

Another possible embodiment assumes that the user of the system has a display screen and a key pad integrated into his or her object having at least one machine-recognizable feature. The user can then instantly view the collected data and delete data of no interest. As well, an interactive messaging system can also be integrated into the object having at least one machine-recognizable feature. Since each device would have an address, the user could communicate to the person of interest through this instant messenger system. The person of interest could either accept the message or block it.

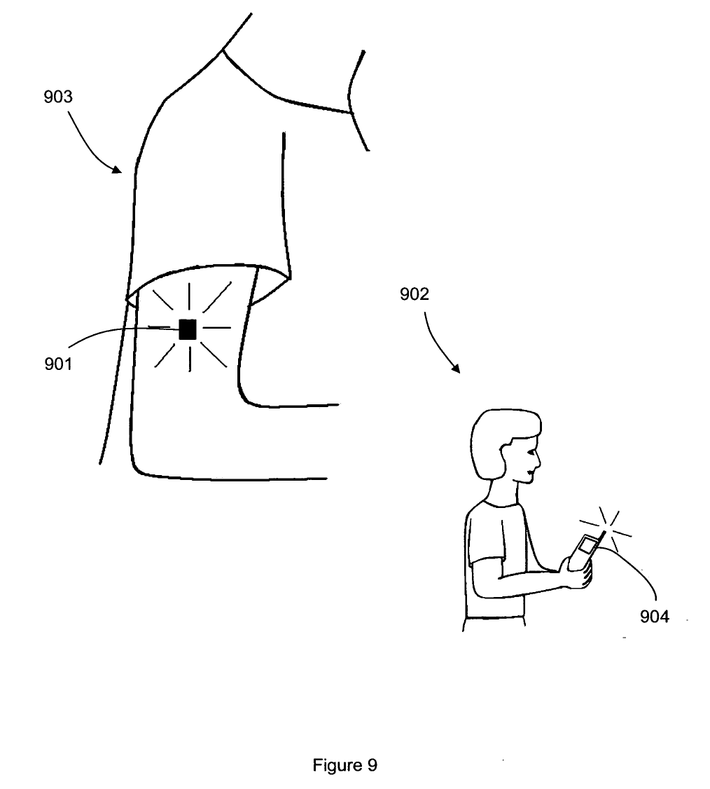

FIG. 9 is another embodiment of the object having at least one machine recognizable feature, where in this case a chip 901, is implanted within a person of interest 903. The chip 901 comprises a transponder that emits a coded electromagnetic signal in response to a signal from a user's 902 feature recognition unit 904. Or else the chip 901 emits a continual or intermittent electromagnetic signal. The electromagnetic signal is received by the user's 902 feature recognition unit 904. The coded information identifies the person of interest 903, could provide an electronic address from which more information about the person of interest 903 can be downloaded by the user 902 of the system, and may also contain a command sequence which causes the unit 904 having the controller to automatically download the information about the person of interest 903.

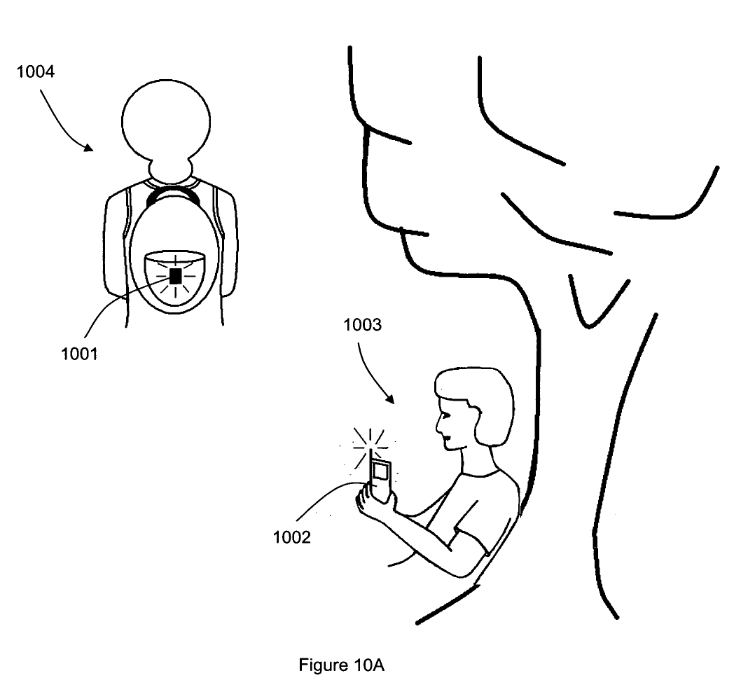

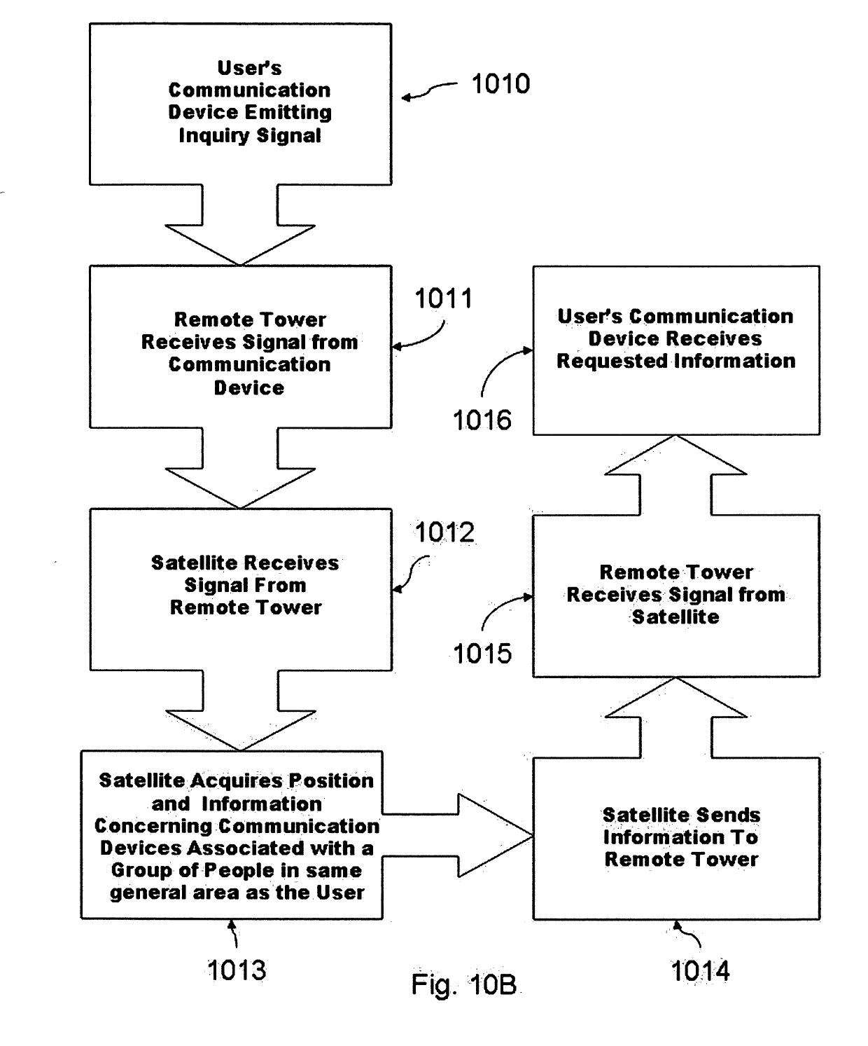

Another embodiment of the invention shown in FIGS. 10A and 10B uses a device-to-device communication method wherein each device contains at least one machine recognizable feature and one feature recognition unit. In the example shown, we see two communication devices, such as web-enabled cellular phones, web-enabled pocket computers, web-enabled hybrid cellular telephone/PDAs, and the like, but other devices with similar functionalities could be used.

FIG. 10A shows the user 1003 enabling his communication device 1002 to connect to the person of interest's 1004 communication device 1001, which, in this example, is stored out of sight. The user's communication device 1002 emits a signal 1010 which can include self-identifying information and data from the person of interest's 1004 communication device 1001 and connects to a remote tower 1011. The tower then connects to a satellite 1012 to acquire the positions of the user's 1003 communication device 1002 and the communication device 1001 of the person of interest 1004, and provide either or both communication devices 1001 and 1002 locating and other information about users and persons of interest in the same general area, 1013. In this example, the satellite sends this information to the remote tower 1015 which provides this information to the communication device 1002 associated with the user 1003, 1016.

The user is now able to view the location of, and other information, about the person of interest 1004 associated with the hidden communication device 1001. This enables the user of the system 1003 to visually identify the person of interest 1004, and, if desired, to send a message to said person of interest's 1004 communication device 1001. Said message could be read at the time or later, just as a phone call can be taken at the time or a voicemail or other message can be accessed later, and said message enable said person of interest 1004 to access a profile of the user 1003. The person of interest 1004 can then decide whether or not to reply to the message sent by the user 1003. These profiles can contain precisely as much data as the user 1003 and the person of interest 1004 are willing to disclose in an initial, tentative contact.

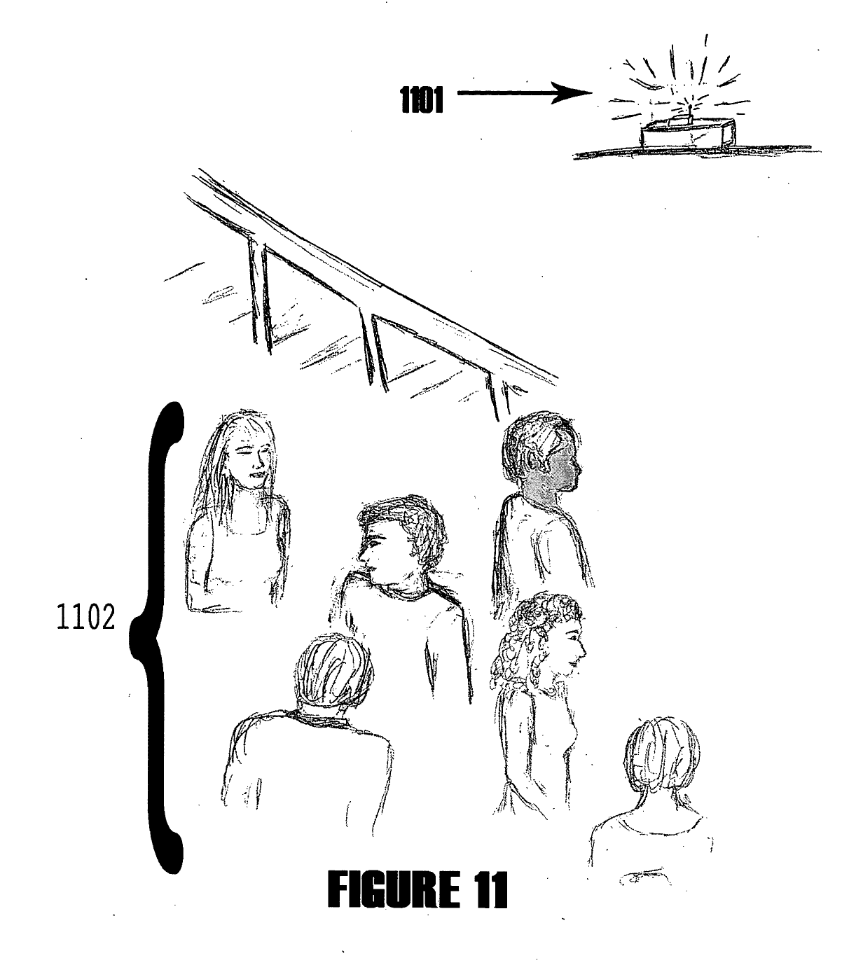

The positioning systems used in this invention can comprise but not limited to a GPS system or a local positioning system as shown in FIG. 11. The local positioning system 1101 located within a facility, in this instance a dance club, could have the dance club mapped out for easy location determination. When the users of the system in the crowd 1102 activated their communication devices, they would be connected to the local positioning network 1101 to retrieve positioning information of persons of interest also located in the crowd 1102.

Any other positioning systems could alternatively be implemented with the invention as a location system. New technology such at WiFi Positioning System (WPS) could be used which works similarly to GPS however it is a “ground based GPS.” The system is implemented through software which picks up WiFi signal strength from tree individual hotspots then compares the signals against a map of known hotspot and triangulates user's location. The system is very usefully since it does not need a clear point of view as the GPS requires, it can work outdoors as well as indoors and like GPS can work globally.

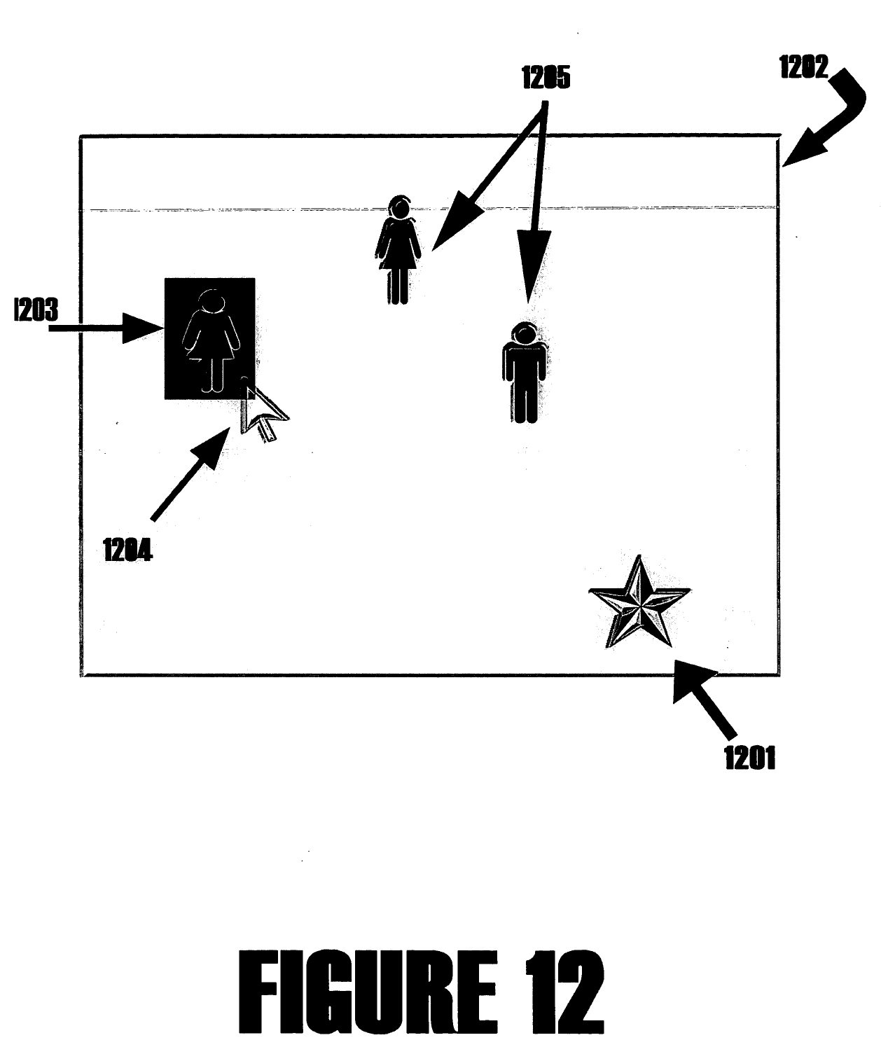

To selectively locate a person of interest in a crowd, the communication device could display the locations of persons of interest associated with communication devices or other objects having at least one machine recognizable feature shown in FIG. 12. With the user's command, the GPS system would locate all of the people in the area associated with objects having at least one machine recognizable feature and display their location 1205 on the communication device screen 1202 of the user 1201. The icons for the people can be as shown in the form of female and male to represent the persons of interest 1205 and 1203 and in the form of a star to represent the user of the system 1201, but other icons could also be used. The user would then select one person of interest 1203 on the screen 1202 of the communication device using a cursor 1204. As the cursor moved over a person of interest 1203, the screen 1202 would highlight that person 1203, and the user of the system could click an ENTER key or otherwise select that particular person of interest 1203. After the selection was made, the communication device would display the data acquired from the object having at least one machine recognizable feature associated with that particular person of interest 1203.

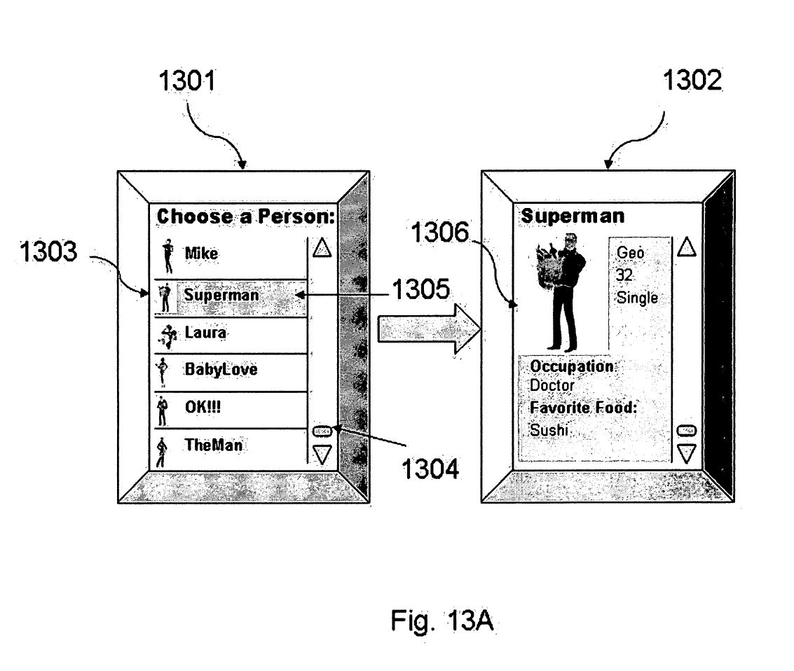

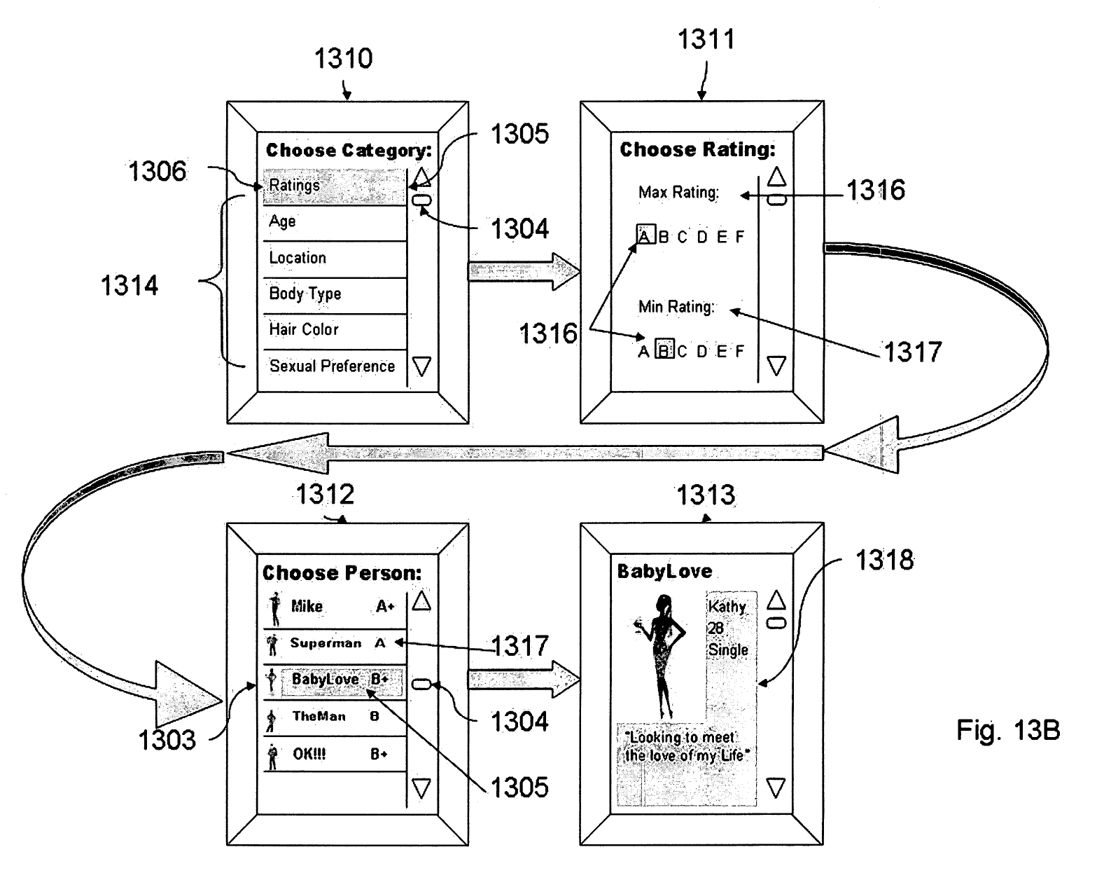

Another embodiment of selectively locating a person of interest is shown in FIG. 13A, which could be used regardless if GPS is available or not. The recognition unit of such a communication device would scan an area containing a group of people and then display some information about each person of interest 1303 on its display screen 1301 in a list format. Each person of interest's information 1303 could consist of a photograph and a brief profile including a plurality of data, such as a real name, or, as shown in the figure, a “club” name, the availability of a product or service, the availability of the person for a certain type of activity, the minimal requirements demanded by the person of interest, the price of a service or a product, and the like. The user could scroll up or down 1304 the list such that the screen would highlight 1305 each person in sequential order. When a particular person of interest 1303 was highlighted, the user could press an ENTER type key to obtain more information, to send his or her own profile, to make a request, to offer to purchase a service or product, or the like. The figure suggests the example in which the user's selection of a newly displayed screen 1302 would display an extensive profile 1306 of person of interest 1303.

A more extensive way using the list format of selecting persons of interest would be achieved through method described in FIG. 13B. After scanning an area containing group of people the recognition unit would allow the user to sort the list according to a method selected by said user. In this example, the recognition unit would display 1310 a list of categories 1514 the user could choose to sort the acquired information about persons of interest. Categories might include but not be limited to ratings of attractiveness or any other type of rating, age, demographic information, financial means, location, occupation, interests, physical traits, skills, and the like. The ratings about the person of interest could be entered by other users of the system which viewed the profile or used the services provided by the person of interest. Alternatively, the ratings could be entered by the person of interest rating him or her self. The user could then select a desired category by moving the scroll cursor 1304 up and down which would highlight 1305 the desired category 1306. The user could then depress an ENTER key or similar button or key to choose the highlighted category 1306, in this case “Rating” of persons of interest. The rating could be of any form to set a standard of attractiveness of the person of interest in the case of meeting people, or the rating of service provided in a case of commercial use. The display 1311 could then prompt the user to establish limits of ratings the user can choose to view. The rating could be set up in various rating scales as A-F, 1-10, 1-100%, and the like. In this case A-F rating is implemented where the user can choose maximum rating 1316 and a minimum rating 1317. If the user highlights the desired letters 1316 A and B, then the unit would display 1512 all the people falling within such criteria, possibly with their rating 1317 listed next to them. The list could be arranged in any desired order-ascending, descending, random, and the like. From here the user would select a person of interest 1303 by scrolling 1304 and highlighting 1305. Once the user made the selection, the extended profile 1318 would be displayed on the screen 1313.

To retrieve information from the object having at least one machine-recognizable feature or to enter and update profiles, an Internet web site could be set up. The people using the system could register on the website and could be given an ID/Password protection to access the information on the website. A profile would be then created depending on the requirements or the application of the system. If the system is used for the purpose of meeting people, the people using the system could create a personal profile including only that information which they choose to make available to potential recipients. The profile could be based on a questionnaire which compiles interests, hobbies, occupation and the like, as well as photographs and time-based audio-visual media clips. However, for example, if the system is used for medical purposes, the profiles would be created by an authorized person and only other authorized people can have the right to access such information.

The users of the system could then download the profiles onto the device to be available for other users of the system to retrieve. Or else, the users could store only an electronic address on the devices, which would enable other users of the system to access information stored on the website.

If the systems used are as described in FIGS. 1-6, then the user 102 can initiate contact with the person of interest 103 by using the contact information provided through the object having at least one machine-recognizable feature 101. The contact information could be but not limited to a Screen Name for Instant messenger, e-mail address, phone number, and the like.

Assume that the system is used as described in FIG. 10A for meeting people, wherein both the user of the system and the person of interest have communication devices 1001 and 1002. In such usage, after viewing the acquired information, the user 1003 can initiate a direct contact with the person of interest's 1004 communication device 1001, using his own communication device 1002 and methods such as but not limited to Instant Messenger, Text Messaging, e-mail, phone conversation, and the like. The person of interest 1004 can respond to the message with his or her communication device 1001, or choose to view the user's 1003 profile first before responding. After viewing the profile, if the person of interest 1004 is not interested, he or she could either transmit a negative reply or block the user's 1003 communication device's 1002 associated address.

Similarly, the system using the same type of aforementioned dual communication device connection could be used at any type of venue to provide information between the devices. The venue could be, but is not limited to a club, night club, bar, lounge, stadium, theater, educational facility, commercial facility, government facility, restaurant, hotel, residence, means of transportation, or the like. After receiving transmitted message and/or other type of information from the person of interest, the user can then chose how to respond to it.

To maintain privacy, the person of interest 1004 may choose not to provide any contact information to the users of the system 1003. In the instance of meeting another individual through a website, the website could have an anonymous manner of connecting individuals. For example, the user 1003 could indicate that he or she is interested in a person of interest 1004, and then the website or other type of medium could notify that person of interest 1004. The person of interest 1004 could request that the user 1003 reciprocate by sending his or her profile. If the person of interest 1004 is interested in contacting the user 1003, the website can set up an anonymous connection between them.

The figures are intended to illustrate and not to limit the scope of the invention. The invention envisions the application of a plurality of means for accessing electronic data about persons of interest and initiating information exchange and/or conducting possible communication between said persons and users of the system.

1-113. (canceled)

114. A system for identifying and accessing electronic data about at least one person of interest to a user, the system comprising:
at least one object containing a machine readable feature;
a feature recognition unit having associated therewith a means for recognizing said machine readable feature;
a transmitter for transmitting a coded signal in response to the recognition of said machine readable feature;
a receiver for receiving said coded signal; and
a means for accessing said electronic data;
wherein said user uses said feature recognition unit to read said machine recognizable feature and thereby extract said electronic data.

115. A system according to claim 114 wherein said at least one object further comprises memory means.

116. A system according to claim 115 wherein said electronic data is stored in said memory means.

117. A system according to claim 114 wherein said electronic data associated with said at least one person of interest is stored on a remote server.

118. A system according to claim 117 wherein said at least one object comprises a data packet that causes said means for accessing said electronic data to access said electronic data stored on said remote server.

119. A system according to claim 114 wherein said user uses said feature recognition unit to scan said machine readable feature to extract said electronic data associated with said at least one person of interest.

120. A system according to claim 114 further comprising a display unit.

121. A system according to claim 120 wherein said electronic data is displayed on said display unit.

122. A system according to claim 114 wherein said electronic data comprises information about said at least one person of interest.

123. A system according to claim 122 wherein said information comprises information selected from the group consisting of profile information, service for hire information, a product or commodity information, and some combination thereof.

124. A system according to claim 114 wherein said electronic data initiates communication between said user and said at least one person of interest.

125. A system according to claim 120 wherein said electronic data comprises the address of a web page.

126. A system according to claim 125 wherein said means for accessing said electronic data automatically accesses said web page.

127. A system according to claim 125 wherein said user is presented with a link to a web page on his or her said display unit and has the option of accessing said web page.

128. A system according to claim 125 wherein said web page contains additional information about said at least one person of interest.

129. A system according to claim 125 wherein said web page contains links to other web pages.

130. A system according to claim 125 wherein said web page contain means for said user to communicate to said at least one person of interest.

131. A system according to claim 114 wherein said feature recognition unit has a communication device associated therewith.

132. A system according to claim 131 wherein said communication device comprises a display unit.

133. A system according to claim 131 wherein said communication device comprises a microprocessor.

134. A system according to claim 131 wherein said communication device further comprises memory means.

135. A system according to claim 114 wherein said feature recognition unit further comprises:
a proximity sensor for setting boundaries;
wherein said user sets said proximity sensor and uses said feature recognition unit to read said machine recognizable feature located in said boundaries and thereby extract said electronic data associated with said at least one person of interest.

136. A system for identifying and accessing electronic data about at least one person of interest to a user, the system comprising:
at least one communication device that has a machine readable feature;
at least one other communication device having associated therewith a means for recognizing said machine readable feature;
a transmitter for transmitting a coded signal in response to the recognition of said machine readable feature;
a receiver for receiving said coded signal; and
a means for accessing said electronic data;
wherein said user uses said recognition means to read said machine recognizable feature and extract said electronic data.

137. A system according to claim 136 wherein said at least one communication device that has a machine readable feature further comprises memory means.

138. A system according to claim 137 wherein said electronic data is stored in said memory means.

139. A system according to claim 136 wherein said electronic data associated with said at least one person of interest is stored on a remote server.

140. A system according to claim 139 wherein said at least one communication device that has a machine readable feature comprises a data packet that causes said means for accessing said electronic data to access said electronic data stored on said remote server.

141. A system according to claim 136 wherein said user uses said at least one other communication device having associated therewith a means for recognizing said machine readable feature to scan said machine readable feature to extract said electronic data associated with said at least one person of interest.

142. A system according to claim 136 further comprising a display unit.

143. A system according to claim 142 wherein said electronic data is displayed on said display unit.

144. A system according to claim 136 wherein said electronic data comprises information about said at least one person of interest.

145. A system according to claim 144 wherein said information comprises information selected from the group consisting of profile information, service for hire information, a product or commodity information, and some combination thereof.

146. A system according to claim 136 wherein said electronic data initiates communication between said user and said at least one person of interest.

147. A system according to claim 142 wherein said electronic data comprises the address of a web page.

148. A system according to claim 147 wherein said means for accessing said electronic data automatically accesses said web page.

149. A system according to claim 147 wherein said user is presented with a link to a web page on his or her said display unit and has the option of accessing said web page.

150. A system according to claim 147 wherein said web page contains additional information about said at least one person of interest.

151. A system according to claim 147 wherein said web page contains links to other web pages.

152. A system according to claim 147 wherein said web page contain means for said user to communicate to said at least one person of interest.

153. A system according to claim 142 further comprising:
a positioning system;
wherein said positioning system locates said at least one communication device that has a machine readable feature;
wherein said display unit displays the location of said at least one communication device that has a machine readable feature; and
wherein said user specifies the position of said at least one person of interest associated with at least one communication device that has a machine readable feature to access said electronic data about said at least one person of interest.

154. A system according to claim 136 wherein said at least one other communication device having associated therewith a means for recognizing said machine readable feature further comprises:
a proximity sensor for setting boundaries;
wherein said user sets said proximity sensor and uses said recognition means to read said machine recognizable feature located in said boundaries and thereby extract said electronic data.

155. A method of selecting data from a first communication device, said method comprising steps of:
providing said first communication device having associated therewith a display unit and a means for recognizing said machine readable feature;
providing a second communication device that has a machine readable feature associated with at least one person of interest;
selecting at least one search criterion;
scanning said second communication device;
accessing electronic data associated with said second communication device;
comparing said electronic data to said at least one search criterion to find matching data; and
displaying said matching data on said display unit to a user.

156. A method according to claim 155 wherein said at least one search criterion are at least one selected from the group consisting of attractiveness, financial means, interest, physical traits, and skills.

157. A method according to claim 155 wherein said electronic data indicates whether said at least one person of interest has a commodity, service, or product for sale.

158. A method according to claim 157 wherein said electronic data indicates the terms for purchase of said commodity, service, or product.

159. A method according to claim 155 wherein said electronic data indicates how said user may communicate to said at least one person of interest.
